(19) United States
(12) Patent Application Publication
(10) Pub. No.: US 2026/0142289 A1
(43) Pub. Date: May 21, 2026

(54) SECONDARY BATTERY AND BATTERY PACK INCLUDING THE SECONDARY BATTERY

(71) Applicant: SAMSUNG SDI CO., LTD., Yongin-si (KR)

(72) Inventors: Sang Hyup MOON, Suwon-si (KR); Wan Seok JANG, Suwon-si (KR)

(21) Appl. No.: 19/348,960

(22) Filed: Oct. 3, 2025

(30) Foreign Application Priority Data
Nov. 21, 2024 (KR) 10-2024-0167530

(51) Int. Cl. H01M 50/184; H01M 50/107; H01M 50/152; H01M 50/167; H01M 50/186; H01M 50/213; H01M 50/342; H01M 50/531; H01M 50/578; H01M 50/586

(52) U.S. Cl. CPC H01M 50/184; H01M 50/152; H01M 50/167; H01M 50/186; H01M 50/3425; H01M 50/531; H01M 50/578; H01M 50/586; H01M 50/107; H01M 50/213

(57) ABSTRACT

A secondary battery includes a case having an opening formed therein. An electrode assembly is accommodated in the case. A cap assembly seals the opening and is electrically connected to the electrode assembly. A gasket is disposed between the cap assembly and the case to insulate between the cap assembly and the case, with the gasket including a concave groove in a portion of the gasket that faces in a direction towards the electrode assembly.

### CROSS-REFERENCE TO RELATED APPLICATION

The present application claims priority to and the benefit of Korean Patent Application No. 10-2024-0167530, filed on Nov. 21, 2024, in the Korean Intellectual Property Office, the entire disclosure of which is incorporated herein by reference.

### BACKGROUND

### 1. Field of the Disclosure

The present disclosure relates to a secondary battery and a battery pack including the secondary battery.

### 2. Discussion of Related Art

With the rapid spread of electronic devices that use batteries, such as portable phones, laptop computers, and electric vehicles, the demand for high energy density and high-capacity secondary batteries has rapidly increased. Accordingly, research and development to improve the performance of lithium secondary batteries is actively being conducted.

A lithium secondary battery includes a positive electrode and a negative electrode, which each include active materials capable of intercalation and deintercalation of lithium ions, and an electrolyte. A lithium secondary battery produces electrical energy through oxidation and reduction reactions when lithium ions are intercalated/deintercalated into/from the positive electrode and negative electrode.

The information disclosed in this background section is provided for enhancement of understanding of the background of the present disclosure. It may contain information that does not constitute related (or prior) art.

### SUMMARY OF THE DISCLOSURE

The present disclosure is directed to providing a secondary battery having internal components with improved structural strength and a battery pack including the secondary battery.

The present disclosure is also directed to providing a secondary battery with a reduced failure rate and a battery pack including the secondary battery.

These and other aspects and features of the present disclosure will be described in or will be apparent from the following description of some embodiments of the present disclosure.

According to an aspect of the present disclosure, there is provided a secondary battery including: a case having an opening formed therein; an electrode assembly accommodated in the case; a cap assembly that seals the opening and is electrically connected to the electrode assembly; and a gasket disposed between the cap assembly and the case to insulate between the cap assembly and the case, the gasket including a concave groove n a portion of the gasket that faces in a direction towards the electrode assembly.

The cap assembly may include: an upper cap exposed to outside of the case; a vent plate disposed between the upper cap and the electrode assembly, the vent plate being electrically connected to the upper cap; and a lower cap disposed between the vent plate and the electrode assembly, the lower cap being electrically connected to the vent plate and the electrode assembly.

The cap assembly may further include a cap assembly insulating member that is between the vent plate and the electrode assembly, the cap assembly including an insulating material.

The case may include: a crimping side portion extending parallel to a longitudinal direction of the case; and a crimping portion extending from the crimping side portion and bent toward a center of the opening, and the gasket contacts an inner side of the crimping side portion and an inner side of the crimping portion.

An upper portion of the gasket is in contact with the inner side of the crimping side portion and the inner side of the crimping portion, and the concave portion is positioned at a lower portion of the gasket.

The secondary battery may further include an insulating plate disposed between the electrode assembly and the gasket.

The gasket may include: a crimping contact portion extending from a position adjacent to the case and disposed between a crimping portion bent toward a center of the opening and the cap assembly; a connecting portion connected to the crimping contact portion, the connecting portion being bent and extending toward the electrode assembly, and the connecting portion being disposed between the case and the cap assembly; a support portion connected to the connecting portion, the support portion being bent and extending toward the center of the opening; and a leg portion connected to the support portion, the leg portion being bent and extending toward the electrode assembly.

The leg portion may include: a leg inner end portion disposed toward the center of the opening; a leg outer end portion disposed toward the case; and a leg step portion disposed between the leg inner end portion and the leg outer end portion.

The concave groove is formed in the leg step portion.

A width of the concave groove may be 3.0 mm to 6.0 mm and a depth of the concave groove may be 0.08 mm to 0.15 mm.

The gasket may further include a burr protruding from the concave groove toward the electrode assembly.

The burr may be spaced 0.03 mm to 0.15 mm from the leg inner end portion.

A diameter of the burr may be 0.2 mm to 0.8 mm and a height of burr may be 0.005 mm to 0.08 mm.

According to another aspect of the present disclosure, there is provided a battery pack including: a housing; and a plurality of secondary batteries disposed inside the housing, wherein each of the secondary batteries includes: a case having an opening formed therein; an electrode assembly accommodated in the case; a cap assembly that seals the opening and is electrically connected to the electrode assembly; and a gasket disposed between the cap assembly and the case to insulate between the cap assembly and the case, the gasket a concave groove in a portion of the gasket that faces in a direction towards the electrode assembly.

The cap assembly may include: an upper cap exposed to outside of the case; a vent plate disposed between the upper cap and the electrode assembly, the vent plate being electrically connected to the upper cap; and a lower cap disposed between the vent plate and the electrode assembly, the lower cap being electrically connected to the vent plate and the electrode assembly.

The case may include: a crimping side portion extending parallel to a longitudinal direction of the case; and a crimping portion extending from the crimping side portion and bent toward a center of the opening, and the gasket contacts an inner side of the crimping side portion and an inner side of the crimping portion.

An upper portion of the gasket is in contact with the inner side of the crimping side portion and the inner side of the crimping portion, and the concave portion may be positioned at a lower portion of the gasket.

The gasket may include: a crimping contact portion that extends from a position adjacent to the case and is disposed between a crimping portion bent toward a center of the opening and the cap assembly; a connecting portion connected to the crimping contact portion, the connecting portion being bent and extending toward the electrode assembly, and the connecting portion disposed between the case and the cap assembly; a support portion connected to the connecting portion, the support portion being bent and extending toward the center of the opening; and a leg portion connected to the support portion, the leg portion being bent and extending toward the electrode assembly.

The leg portion may include: a leg inner end portion disposed toward the center of the opening; a leg outer end portion disposed toward the case; and a leg step portion disposed between the leg inner end portion and the leg outer end portion.

The concave groove may be formed in the leg step portion.

### BRIEF DESCRIPTION OF THE DRAWINGS

The drawings attached to this specification illustrate some embodiments of the present disclosure and further describe aspects and features of the present disclosure together with the detailed description of the present disclosure. However, the present disclosure should not be construed as being limited to the drawings, in which:

FIG. 1 is a perspective view of a configuration of a battery pack according to an embodiment of the present disclosure;

FIG. 2 is a perspective view of a configuration of a secondary battery according to an embodiment of the present disclosure;

FIG. 3 is an exploded perspective view of a configuration of the secondary battery according to an embodiment of the present disclosure;

FIG. 4 is a cross-sectional view of a configuration of the secondary battery according to an embodiment of the present disclosure;

FIG. 5 is a cross-sectional view of a portion of the secondary battery according to an embodiment of the present disclosure;

FIG. 6 is a perspective view of a gasket according to an embodiment of the present disclosure;

FIG. 7 is a cross-sectional view of a portion of the gasket according to an embodiment of the present disclosure; and

FIG. 8 is a side view of a portion of the gasket according to an embodiment of the present disclosure viewed from the outside.

### DETAILED DESCRIPTION OF EXEMPLARY EMBODIMENTS

Herein, embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected to, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an element is referred to as being disposed (or located or positioned) on the “above (or below)” or “on (or under)” a component, it may mean that the element is placed in contact with the upper (or lower) surface of the component and may also mean that another component may be interposed between the component and any element disposed (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

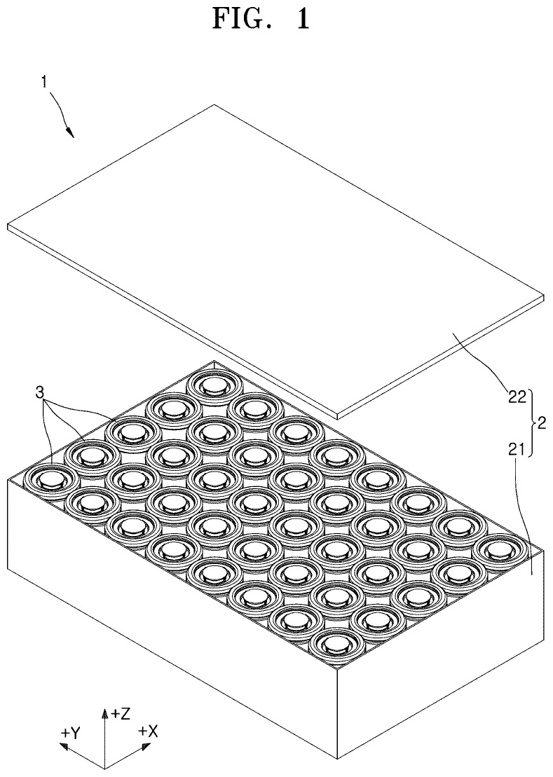

FIG. 1 is a perspective view of a configuration of a battery pack according to an embodiment of the present disclosure.

Referring to FIG. 1, a battery pack 1 according to various embodiments may include a housing 2, a secondary battery 3, and a busbar (not illustrated). The housing 2 may form an exterior of the battery pack 1 and may provide a space in which the secondary battery 3 is accommodated.

The housing 2 according to the present embodiment may include a housing body 21 and a housing cover 22. The housing body 21 may be in the shape of a box with an interior and an open side. A cross-sectional shape of the housing body 21 is not limited to the quadrangular shape illustrated in FIG. 1 and may be various other shapes such as polygonal, circular, or oval.

The housing cover 22 may be coupled to the housing body 21 and may close the internal space of the housing body 21. In one example, the housing cover 22 may be substantially plate shaped and may be disposed to face the open side of the housing body 21. The housing cover 22 may be fixed to the housing body 21 by various types of coupling methods such as bolting, welding, fitting, etc.

Secondary batteries 3 may function as unit structures for storing and supplying power in the battery pack 1. A plurality of secondary batteries 3 may be provided. The plurality of secondary batteries 3 may be disposed inside the housing 2 in various patterns such as a grid pattern, a zigzag pattern, or the like. The plurality of secondary batteries 3 may be disposed parallel to each other. The number of secondary batteries 3 may vary depending on the size, shape, etc. of the housing 2. A detailed configuration of the secondary battery will be described below.

The busbar (not illustrated) may electrically connect the plurality of secondary batteries 3. The plurality of secondary batteries 3 may be connected by the busbar in series, in parallel or in series and parallel. For example, the busbar may connect the secondary batteries 3 disposed in the same row inside the housing 2 in parallel to each other, and the secondary batteries 3 disposed in two neighboring rows in series with each other. The busbar may be formed of an electrically conductive material such as copper, aluminum, nickel, or the like.

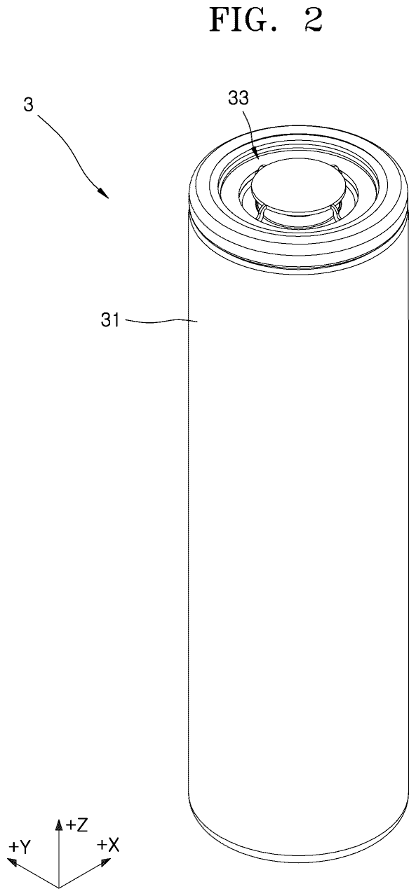

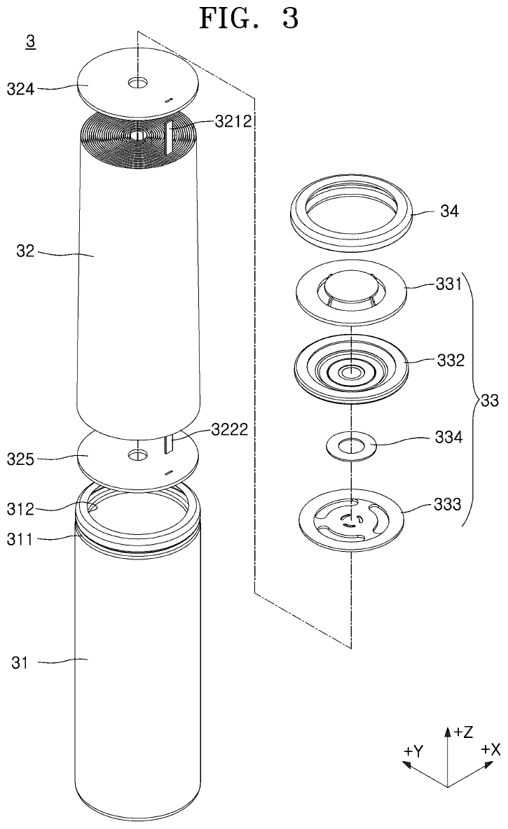

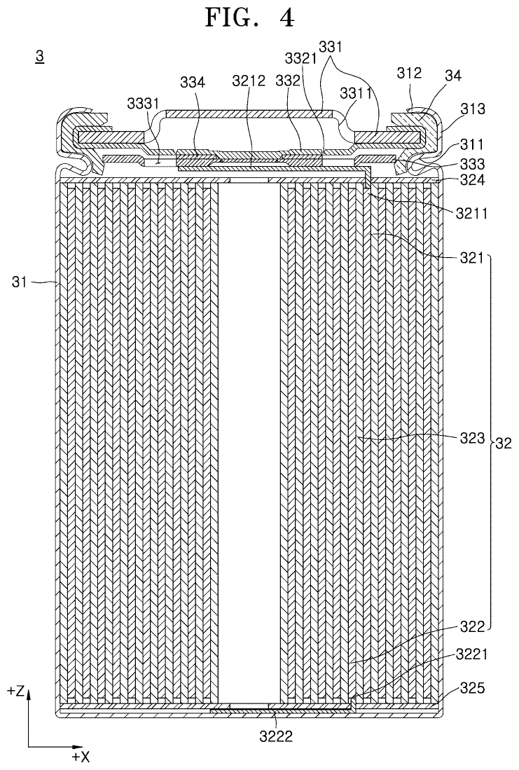

FIG. 2 is a perspective view of a configuration of a secondary battery according to an embodiment of the present disclosure, FIG. 3 is an exploded perspective view of a configuration of the secondary battery according to an embodiment of the present disclosure, and FIG. 4 is a cross-sectional view of a configuration of the secondary battery according to an embodiment of the present disclosure.

Referring to FIGS. 2 to 4, the secondary battery 3 according to the present embodiment may include a case 31, an electrode assembly 32, a cap assembly 33, and a gasket 34.

Hereinafter, an example in which the secondary battery 3 is a cylindrical lithium-ion secondary battery will be described. However, the present disclosure is not limited to this type of battery, and the secondary battery 3 may be, for example, a lithium polymer battery or a prismatic battery.

The case 31 constituting the secondary battery 3 may be provided in various shapes. According to an embodiment, the case 31 may be provided in a circular shape. But the shape of the case 31 is not limited to the circular shape and may be provided, for example, in a prismatic shape including a polygonal bottom surface.

The case 31 includes an opening on one side. The electrode assembly 32 may be inserted into the case 31 through the opening. The case 31 may be formed of a conductive member such as aluminum, may protect the electrode assembly 32 from external impacts, and may function as a heat sink to dissipate heat accompanying the charging and discharging operations of the electrode assembly 32. The bottom surface of the case 31 is electrically connected to a second electrode tab 3222 by welding or the like, and, as such, the case 31 may function as a second electrode.

The electrode assembly 32 may be disposed inside the case 31. The electrode assembly 32 may function as a unit structure that performs charging and discharging operations of power in the secondary battery. The electrode assembly 32 may include a first electrode plate 321, a second electrode plate 322, and a separator 323 disposed between the first electrode plate 321 and the second electrode plate 322.

The electrode assembly 32 may be wound around a winding axis. More specifically, the electrode assembly 32 may have a shape wound around the winding axis clockwise or counterclockwise in a state where the first electrode plate 321, the separator 323, and the second electrode plate 322 are stacked. Thus, the electrode assembly 32 may have a substantially jelly roll shape. The cross-sectional shape of the electrode assembly 32 may be various shapes such as an oval shape, a polygonal shape, or the like as alternatives to the circular shape. Here, the winding axis may refer to a straight line passing the center of the electrode assembly 32.

The first electrode plate 321 may function as a positive electrode of the electrode assembly 32. The first electrode plate 321 may be a foil including a metal material such as aluminum or an aluminum alloy. The type, size, and shape of the first electrode plate 321 are not particularly limited so as long as it is conductive and does not cause chemical changes in the secondary battery.

At least a portion of the first electrode plate 321 may be coated with a first active material layer. Both surfaces of the first electrode plate 321 may be coated with the first active material layer or only one surface of the first electrode plate 321 may be coated with the first active material layer.

Since the first electrode plate 321 functions as a positive electrode, the first active material layer may include a positive active material. The positive electrode active material may be a compound capable of reversible intercalation and deintercalation of lithium (lithiated intercalation compound). More specifically, one or more of a composite oxide of lithium and a metal selected from cobalt, manganese, nickel, and a combination thereof may be used. In one example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNixCoyMnzO₂, NCM). Here, 0<x<1, 0<y<1, 0<z<1, and x+y+z=1. The positive electrode active material may include one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM), and may include any two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM).

The first active material layer may further include a positive electrode conductive material. The positive electrode conductive material is used to impart conductivity to the first active material layer and any electronically conductive material that does not cause a chemical change may be used. Examples of the positive electrode conductive material include a carbon-based material such as natural graphite, artificial graphite, carbon black, acetylene black, Ketjen black, carbon fibers, carbon nanofibers, and carbon nanotubes, a metal-based material in the form of a metal powder or metal fiber containing copper, nickel, aluminum, silver, etc., a conductive polymer such as a polyphenylene derivative, or a mixture thereof.

The first active material layer may further include a positive electrode binder. The positive electrode binder serves to attach particles constituting the positive electrode active material to each other and also to attach the positive electrode active material to the first electrode plate 321 well.

Examples of the positive electrode binder include a non-aqueous binder, an aqueous binder, a dry binder, or a combination thereof.

Examples of the non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, or a combination thereof.

When the aqueous binder is used as the positive electrode binder, a cellulose-based compound capable of imparting viscosity may be further included. As the cellulose-based compound, one or more of carboxymethyl cellulose, hydroxypropylmethyl cellulose, methyl cellulose, and alkali metal salts thereof may be mixed and used. As the alkali metal, Na, K, or Li may be used.

The dry binder may be a polymeric material capable of being fiberized. Examples of the dry binder include polytetrafluoroethylene, polyvinylidene fluoride, a polyvinylidene fluoride-hexafluoropropylene copolymer, polyethylene oxide, or a combination thereof.

The first electrode plate 321 may include a first uncoated portion 3211 on which the first active material layer is not applied. The first uncoated portion 3211 may protrude in the direction of the winding axis a predetermined distance from an end of the electrode assembly 32.

The second electrode plate 322 may function as a negative electrode of the electrode assembly 32. The second electrode plate 322 may be a foil including a metal material such as copper, a copper alloy, nickel, or a nickel alloy. The second electrode plate 322 may be disposed to face the first electrode plate 321 at a predetermined distance therefrom. The type, size, and shape of the second electrode plate 322 are not limited as long as it is conductive and does not cause a chemical change in the secondary battery.

At least a portion of the second electrode plate 322 may be coated with a second active material layer. Both surfaces of the second electrode plate 322 may be coated with the second active material layer, or alternatively, only one surface of the second electrode plate 322 may be coated with the second active material layer.

Since the second electrode plate 322 functions as a negative electrode, the second active material layer may include a negative electrode active material. The negative electrode active material may include a material capable of reversibly intercalating/deintercalating lithium ions, lithium metal, an alloy of lithium and a metal, a material capable of doping and dedoping lithium, or a transition metal oxide.

The material capable of reversibly intercalating/deintercalating lithium ions may be a carbon-based negative electrode active material, for example, crystalline carbon, amorphous carbon, or a combination thereof. Examples of the crystalline carbon may include graphite such as amorphous, plate-like, flaky, spherical, or fibrous natural graphite or artificial graphite, and examples of the amorphous carbon may include soft carbon or hard carbon, mesophase pitch carbide, calcined coke, and the like.

As the alloy of lithium and a metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or Sn-based negative electrode active material may be used. The Si-based negative electrode active material may include silicon, a silicon-carbon composite, SiOₓ (0<x<2), a Si-Q alloy, group 15 elements, group 16 elements, transition metals, rare earth elements, and a combination thereof), or a combination thereof. In the formula Si-Q, Q may be selected from alkali metals, alkaline earth metals, group 13 elements, group 14 elements (excluding Si). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in the form of silicon particles whose surfaces are coated with amorphous carbon. For example, the silicon-carbon composite may include secondary particles (core) in which silicon primary particles are assembled and an amorphous carbon coating layer (shell) located on the surfaces of the secondary particles. The amorphous carbon may also be located between the silicon primary particles, for example, the silicon primary particles may be coated with the amorphous carbon. The secondary particles may be dispersed in an amorphous carbon matrix.

The silicon-carbon composite may further include crystalline carbon. The silicon-carbon composite may include, for example a core including crystalline carbon and silicon particles and an amorphous carbon coating layer located on a surface of the core.

The Si-based negative electrode active material or Sn-based negative electrode active material may be used in combination with the carbon-based negative electrode active material.

The second active material layer may further include a negative electrode conductive material and a negative electrode binder.

The negative electrode conductive material is used to impart conductivity to the second active material layer, and any electronically conductive material that does not cause a chemical change may be used. Examples of the negative electrode conductive material include natural graphite, artificial graphite, carbon black, acetylene black, Ketjen black, carbon-based materials such as carbon fibers, carbon nanofibers, carbon nanotubes, etc., a metal-based material in the form of a metal powder or metal fiber including copper, nickel, aluminum, silver, etc., a conductive polymer such as a polyphenylene derivative, or a mixture thereof.

The negative electrode binder functions to attach the negative electrode active material particles to each other and also attach the negative electrode active material to the second electrode plate 322 well.

Examples of the negative electrode binder include a non-aqueous binder, an aqueous binder, a dry binder, or a combination thereof.

Examples of the non-aqueous binder include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, and a combination thereof.

When the aqueous binder is used as the negative electrode binder, a cellulose-based compound capable of imparting viscosity may also be included. As the cellulose-based compound, one or more of carboxymethyl cellulose, hydroxypropylmethyl cellulose, methyl cellulose, and alkali metal salts thereof may be mixed and used. As the alkali metal, Na, K, or Li may be used.

The dry binder may be a polymeric material capable of being fiberized, for example, polytetrafluoroethylene, polyvinylidene fluoride, a polyvinylidene fluoride-hexafluoropropylene copolymer, polyethylene oxide, or a combination thereof.

The second electrode plate 322 may include a second uncoated portion 3221 that is not coated with the second active material layer. The second uncoated portion 3221 may protrude a predetermined distance from an end portion of the electrode assembly 32 located on the opposite side of the first uncoated portion 3211 in the direction of the winding axis.

A first electrode tab 3212 is electrically connected to the first electrode plate 321, and the second electrode tab 3222 is electrically connected to the second electrode plate 322. The first electrode tab 3212 may have an end connected to the first uncoated portion 3211 by welding or the like, and the other end may be electrically connected to an upper cap 331. The second electrode tab 3222 may have an end connected to the second uncoated portion 3221 by welding or the like, and the other end may be welded to the bottom surface of the case 31.

The first electrode tab 3212 may be directly connected to the first electrode plate 321 and may be indirectly connected to the first electrode plate 321 by a first current collector plate (not illustrated) disposed between the electrode assembly 32 and a first insulating plate 324.

The second electrode tab 3222 may be directly connected to the second electrode plate 322 and may be indirectly connected to the second electrode plate 322 by a second current collector plate (not illustrated) disposed between the electrode assembly 32 and a second insulating plate 325.

The separator 323 may be disposed between the first electrode plate 321 and the second electrode plate 322. The separator 323 may function to prevent a short circuit between the first electrode plate 321 and the second electrode plate 322 while allowing lithium ions to move between the first electrode plate 321 and the second electrode plate 322. As the separator 323, polyethylene, polypropylene, polyvinylidene fluoride, or a multilayer film of two or more layers thereof may be used, and a mixed multilayer separator such as a polyethylene/polypropylene two-layer separator, a polyethylene/polypropylene/polyethylene three-layer separator, a polyethylene/polyethylene/polypropylene three-layer separator, etc. may be used.

The separator 323 may include a porous substrate and a coating layer including an organic material, an inorganic material, or a combination thereof located on one or both surfaces of the porous substrate.

The porous substrate may be a polymer film formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, TEFLON®, and polytetrafluoroethylene, or a copolymer or mixture of two or more thereof.

The organic material may include a polyvinylidene fluoride-based polymer or a (meth)acrylic-based polymer.

The inorganic material may include, but is not limited thereto, inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof.

The organic material and the inorganic material may be present as a mixture in a single coating layer. As an alternative, the organic and inorganic materials may be present in a form in which a coating layer including an organic material and a coating layer including an inorganic material are stacked.

The separator 323 may be provided as a pair. The pair of separators 323 may be disposed to face both surfaces of the first electrode plate 321 or the second electrode plate 322. The pair of separators 323 may be wound around a winding axis together with the first electrode plate 321 and the second electrode plate 322.

In the case 31, the first insulating plate 324 and the second insulating plate 325 may be disposed at end portions of the electrode assembly 32. The first insulating plate 324 may be disposed between an upper surface (e.g., in a +Z-axis direction) of the electrode assembly 32 and the cap assembly 33 to insulate between the electrode assembly 32 and the cap assembly 33, and the second insulating plate 325 may be disposed between a lower surface (e.g., in a −Z-axis direction) of the electrode assembly 32 and the bottom surface of the case 31 to insulate between the electrode assembly 32 and the case 31.

The cap assembly 33 may block the current when pressure inside the case 31 increases. The cap assembly 33 may rupture due to increased pressure inside the case 31 such that the inside of the case 31 is open to the outside of the case 31. As such, the pressure inside the case 31 may be reduced, thereby reducing the risk of explosion of the secondary battery 3.

The cap assembly 33 may be combined with the case 31 to seal the opening of the case 31. Specifically, a beading portion 311 is formed to be concave inward in the case 31, and a crimping portion 312 is formed by bending an upper portion of the case 31 inward on an upper portion of the cap assembly 33 so that the cap assembly 33 may be combined with the case 31. The beading portion 311 and the crimping portion 312 may firmly fix and support the cap assembly 33 to the case 31 to prevent the cap assembly 33 from being separated from the case 31 and also to prevent the electrolyte from leaking to the outside.

The cap assembly 33 may include the upper cap 331, a vent plate 332, a lower cap 333, and a cap assembly insulating member 334.

The upper cap 331 may be electrically connected to the electrode assembly 32. According to an embodiment, the upper cap 331 may be electrically connected to the first electrode plate 321 to function as a positive electrode. The upper cap 331 may be disposed to protrude outside of the case 31.

The cap assembly 33 may include an upper cap hole 3311 that passes through the upper cap 331. Gas generated in the case 31 may be discharged to outside of the case 31 through the upper cap hole 3311.

The vent plate 332 may be disposed between the upper cap 331 and the electrode assembly 32. According to an embodiment, the vent plate 332 may be disposed on a lower portion of the upper cap 331. The vent plate 332 may be electrically connected to the upper cap 331. A portion of the upper cap 331 may be surrounded by the vent plate 332. According to an embodiment, both surfaces of an end portion of the upper cap 331 may be surrounded by the vent plate 332 and may come into contact with the vent plate 332. Accordingly, the upper cap 331 may be fixed to the vent plate 332. The upper cap 331 may be electrically connected to the electrode assembly 32.

The vent plate 332 may move as the pressure inside the case 31 increases. According to an embodiment, as the pressure inside the case 31 increases, the vent plate 332 may move closer to the upper cap 331. As the vent plate 332 moves closer to the upper cap 331, the volume inside the case 31 may increase and the pressure inside the case 31 may decrease.

As the vent plate 332 moves, the vent plate 332 may be electrically disconnected from the lower cap 333 and/or the electrode assembly 32. In this way, as the pressure inside the case 31 increases, the vent plate 332 moves, the electrical connection between the vent plate 332 and the electrode assembly 32 is disconnected, and a sudden explosion of the secondary battery 3 may be prevented.

The vent plate 332 may include a vent plate notch 3321. The vent plate notch 3321 may be provided as a concave groove. As the vent plate notch 3321 is formed in the vent plate 332, the vent plate notch 3321 may rupture before other portions of the vent plate 332. As the vent plate notch 3321 ruptures before other portions of the vent plate 332, the inside of the case 31 may open to outside of the case 31. The pressure inside the secondary battery 3 may be lowered as gas is discharged through the ruptured portion of the vent plate notch 3321 and the upper cap hole 3311. Thus, an explosion of the secondary battery 3 may be prevented.

Since the cap assembly 33 includes the vent plate 332, when the pressure inside the case 31 exceeds a predetermined pressure, gas may be discharged and an explosion of the secondary battery 3 may be prevented.

The lower cap 333 may be disposed between the vent plate 332 and the electrode assembly 32. According to an embodiment, the lower cap 333 may be disposed on a lower portion of the vent plate 332. The lower cap 333 may be electrically connected to the vent plate 332 and the electrode assembly 32. And the lower cap 333 may support the vent plate 332 to prevent deformation of the vent plate 332.

The cap assembly 33 may include a lower cap hole 3331 that passes through the lower cap 333. The lower cap hole 3331 extend to both sides of the lower cap 333 (e.g., in the Z-axis direction). Since the lower cap hole 3331 is disposed on each of both sides of the lower cap 333, gas generated by the electrode assembly 32 inside the case 31 may move through the lower cap hole 3331. Accordingly, when the pressure inside the case 31 increases, the increased pressure may act on the vent plate 332.

A plurality of lower cap holes 3331 may be provided. According to an embodiment, the lower cap hole 3331 may have a long hole shape. But the shape of the lower cap hole 3331 is not limited to the long hole and may be provided in various other shapes.

The cap assembly insulating member 334 may be disposed between the vent plate 332 and the lower cap 333. The cap assembly insulating member 334 may include an insulating material, and, thus, may not be electrically conductive.

The cap assembly insulating member 334 may be disposed between the vent plate 332 and the lower cap 333, and the vent plate 332 and the lower cap 333 may not be electrically connected due to the cap assembly insulating member 334. Accordingly, the vent plate 332 and the lower cap 333 may be electrically connected only through direct contact between the vent plate 332 and the lower cap 333.

The cap assembly insulating member 334 may include polypropylene (PP), polybutylene terephthalate (PBT), polyethylene (PE), a fluoropolymer, etc. The cap assembly insulating member 334 may be manufactured by injection molding. Accordingly, the cap assembly insulating member 334 may be formed as an integral structure.

The vent plate 332 may be disposed on an upper portion of the cap assembly insulating member 334, and the lower cap 333 may be disposed on a lower portion of the cap assembly insulating member 334. As the cap assembly insulating member 334 is disposed between the vent plate 332 and the lower cap 333, the cap assembly insulating member 334 may support the vent plate 332. As the cap assembly insulating member 334 supports the vent plate 332, deformation of the vent plate 332 may be prevented.

The cap assembly insulating member 334 may be provided in a circular shape. But the shape of the cap assembly insulating member 334 is not limited to a circular shape and may be provided in various other shapes such as a triangular shape, a quadrangular shape, etc.

Additionally, when the pressure increases inside the case 31, the vent plate 332 moves toward the upper cap 331 so that the vent plate 332 is electrically disconnected from the electrode assembly 32. In other words, as the vent plate 332 is supported by the cap assembly insulating member 334, the vent plate 332 may move toward the upper cap 331 under the designed conditions.

An adhesive may be disposed on an exterior of the cap assembly insulating member 334 so that the cap assembly insulating member 334 is attached and fixed to the vent plate 332 and/or the lower cap 333. As the cap assembly insulating member 334 is attached and fixed to the vent plate 332 and/or the lower cap 333, the amount of deformation of the vent plate 332 may be reduced.

The gasket 34 may be disposed at a side of the case 31 in a substantially ring shape. In particular, the gasket 34 may be disposed on the inner side of the case 31. According to an embodiment, the gasket 34 may be disposed in the opening formed in the case 31, and the gasket 34 may be disposed closer to a center of the opening than the case 31.

The gasket 34 may fix the cap assembly 33 according to the shape of the beading portion 311 and/or the crimping portion 312. In particular, the gasket 34 may fix the upper cap 331, the vent plate 332, and/or the clower ap333 of the cap assembly 33. The gasket 34 may insulate the upper cap 331, the vent plate 332, and the lower cap 333 from the case 31.

The gasket 34 may be disposed on the inner surface of the beading portion 311 and/or the crimping portion 312 to wrap around the vent plate 332. As the gasket 34 is wrapped around the vent plate 332, the vent plate 332 may be insulated from the case 31. The gasket 34 may be disposed on the inner surface of the beading portion 311 to contact the lower cap 333, and as the gasket 34 comes into contact with the lower cap 333, the lower cap 333 may be insulated from the case 31. The lower cap 333 may be supported by the gasket 34.

As the gasket 34 supports the lower cap 333, the lower cap 333 comes into contact with the cap assembly insulating member 334, and the cap assembly insulating member 334 disposed between the vent plate 332 and the lower cap 333 supports the vent plate 332, the amount of deformation occurring in the vent plate 332 may be reduced by the vent plate 332 and the cap assembly insulating member 334.

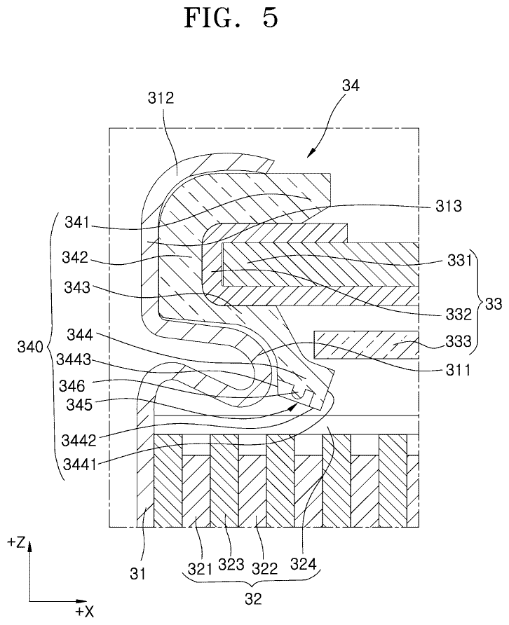

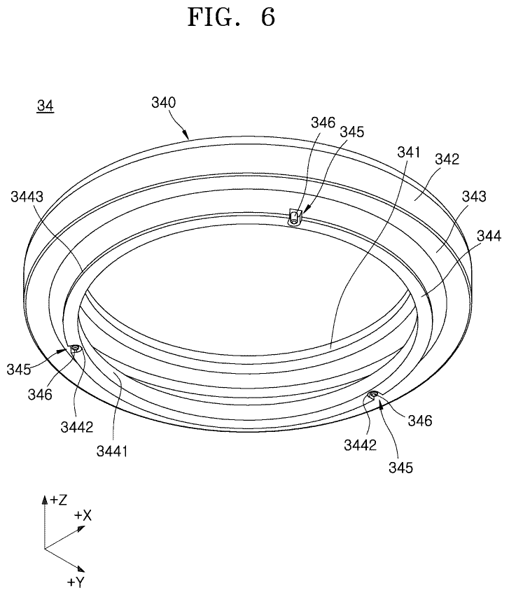

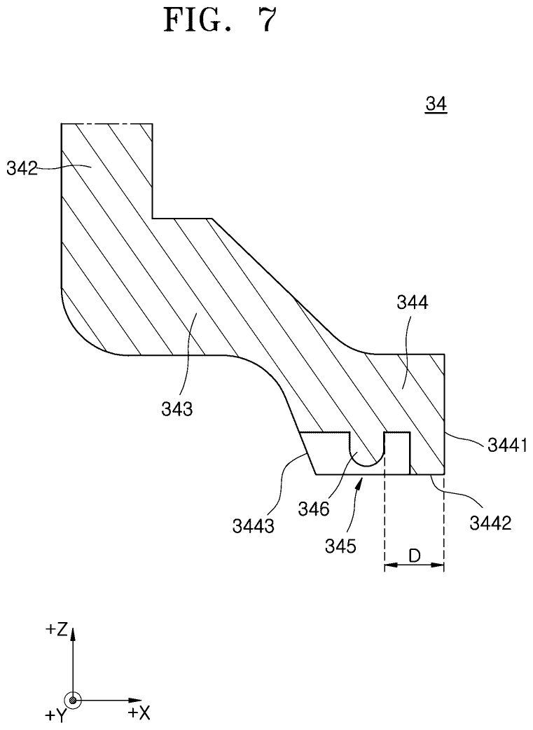

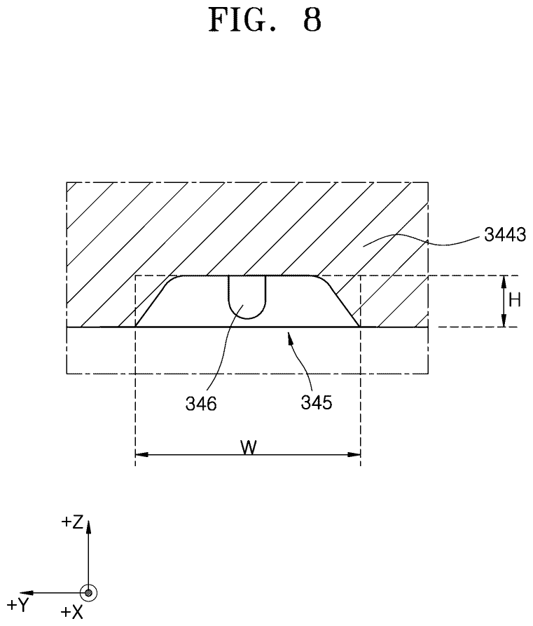

FIG. 5 is a cross-sectional view of a portion of the secondary battery according to an embodiment of the present disclosure, FIG. 6 is a perspective view of the gasket according to an embodiment of the present disclosure, FIG. 7 is a cross-sectional view of a portion of the gasket according to an embodiment of the present disclosure, and FIG. 8 is a side view of a portion of the gasket according to an embodiment of the present disclosure viewed from the outside.

Referring to FIGS. 5 to 8, the gasket 34 will be described.

The gasket 34 may include a gasket body 340, a crimping contact portion 341, a connecting portion 342, a support portion 343, a leg portion 344, a concave portion 345, and a burr 346.

The gasket body 340 may be formed in a substantially ring shape. According to an embodiment, the gasket body 340 may be provided in a circular ring shape. The gasket body 340 may be disposed between the case 31 and the cap assembly 33. In particular, the gasket body 340 may be disposed between the beading portion 311, the crimping portion 312, and a crimping side portion 313 of the case 31 and the vent plate 332 of the cap assembly 33. The crimping side portion 313 connects the beading portion 311 and the crimping portion 312 and may be formed parallel to a longitudinal direction (e.g., the Z-axis direction) of the case 31.

The gasket body 340 may be disposed between an upper portion of the vent plate 332 (e.g., in the +Z-axis direction shown in the drawings) and a lower surface of the crimping portion 312 (e.g., in the −Z-axis direction). The gasket body 340 disposed between the upper portion of the vent plate 332 and the lower surface of the crimping portion 312 may be defined as the crimping contact portion 341. The crimping contact portion 341 may receive a downward force (e.g., in the −Z-axis direction) from the crimping portion 312. Accordingly, a space between the crimping portion 312 and the cap assembly 33 may be sealed by the gasket body 340. Also, the vent plate 332 of the cap assembly 33 may be fixed by the crimping portion 312.

The gasket body 340 may be disposed between a side portion of the vent plate 332 (e.g., in a −X axis direction shown in FIG. 5) and an inner surface of the crimping side portion 313 (e.g., in a +X axis direction shown in FIG. 5). The gasket body 340 disposed between the side portion of the vent plate 332 and the inner surface of the crimping side portion 313 may be defined as the connecting portion 342. The connecting portion 342 may extend from the crimping contact portion 341 and may be bent toward the electrode assembly 32. The connecting portion 342 may be compressed between the crimping side portion 313 and the vent plate 332. Thus, the space between the crimping side portion 313 and the cap assembly 33 may be sealed by the gasket body 340. Additionally, the vent plate 332 of the cap assembly 33 may be fixed by the crimping side portion 313.

The gasket body 340 may be disposed between a lower surface of the vent plate 332 (e.g., in the −Z-axis direction shown in FIG. 5) and an inner surface of the beading portion 311 (e.g., in the +Z-axis direction or +X-axis direction shown in FIG. 5). The gasket body 340 disposed between the lower surface of the vent plate 332 and the inner surface of the beading portion 311 may be defined as the support portion 343. The support portion 343 may extend from the connecting portion 342 and may be bent toward a center of the case 31 (e.g., in the +X axis direction shown in FIG. 5).

The support portion 343 may be compressed by contact with the beading portion 311 and the vent plate 332. And the support portion 343 may be supported by the beading portion 311 by contact with the beading portion 311. The support portion 343 supported by the beading portion 311 may contact the vent plate 332, and the vent plate 332, may come into contact with the support portion 343, and may be supported by the support portion 343.

Thus, the vent plate 332 may be supported and fixed by the crimping contact portion 341, the connecting portion 342, and the support portion 343 of the gasket body 340.

The gasket body 340 may be disposed between the inner surface of the beading portion 311 (e.g., in the +X axis direction shown in FIG. 5) and the lower cap 333. The gasket body 340 that is disposed between the inner surface of the beading portion 311 and the lower cap 333 may be defined as the leg portion 344. The leg portion 344 may extend from the support portion 343 and may be bent toward the electrode assembly 32.

A part of the leg portion 344 may contact the beading portion 311. As the leg portion 344 contacts the beading portion 311, the gasket body 340 may be supported by the beading portion 311.

The leg portion 344 may be disposed between the cap assembly 33 and the first insulating plate 324. As the secondary battery 3 is made, the beading portion 311 and the crimping portion 312 may be formed, and the gasket body 340 may be deformed during the manufacturing process.

As the gasket body 340 is deformed, the leg portion 344 may contact the first insulating plate 324. If the leg portion 344 does contact the first insulating plate 324, the first insulating plate 324 may be damaged, and the leg portion 344 may pass through the first insulating plate 324 and come into contact with the electrode assembly 32. Accordingly, when the leg portion 344 is prevented from contacting the first insulating plate 324 and/or the electrode assembly 32, the failure rate of the secondary battery 3 may be reduced. That is, when the contact between the leg portion 344, the first insulating plate 324 and/or the electrode assembly 32 is minimized, the failure rate of the secondary battery 3 may be reduced.

The leg portion 344 may include a leg inner end portion 3441, a leg step portion 3442, and a leg outer end portion 3443. The leg inner end portion 3441 may be disposed to face the center of the case 31 (e.g., in the +X axis direction shown in FIG. 5). The leg outer end portion 3443 may be disposed to face the beading portion 311 of the case 31. The leg step portion 3442 may be disposed between the leg inner end portion 3441 and the leg outer end portion 3443 and may be disposed to face the electrode assembly 32.

The concave portion 345 may be disposed in the leg portion 344. In particular, the concave portion 345 may be formed as a concave groove formed in the leg portion 344. More specifically, the concave portion 345 may be disposed to face the electrode assembly 32 and the concave portion 345 may be formed as a groove that is concavely formed toward the cap assembly 33 (e.g., in the +Z-axis direction). The concave portion 345 may be disposed between the leg inner end portion 3441 and the leg outer end portion 3443. According to an embodiment, the concave portion 345 may be disposed between the leg step portion 3442 and the leg inner end portion 3441.

A plurality of concave portions 345 may be provided. According to an embodiment, the concave portions 345 may be disposed equiangularly with respect to the center of the gasket body 340. In some embodiments, there may be three concave portions 345, but the number of concave portions 345 is not limited to three and may be provided in various numbers.

The burr 346 formed to protrude from the gasket body 340 may be disposed in the concave portion 345. When a plurality of concave portions 345 are provided, a burr 346 may be formed in each of the concave portions 345.

Referring to FIG. 7, in particular embodiments, a separation distance D between one end portion of the burr 346 disposed close to the center of the case 31 (e.g., in the +X axis direction shown in FIG. 7) and the leg inner end portion 3441 may be approximately 0.01 mm to 0.20 mm. More specifically, the separation distance D between one end portion of the burr 346 and the leg inner end portion 3441 may be approximately 0.03 mm to 0.15 mm. Even more specifically, the separation distance D between one end portion of the burr 346 and the leg inner end portion 3441 may be 0.05 mm or more.

That portion of the gasket body 340 at the position where the burr 346 is disposed may be less rigid than other portions of the gasket body 340. As the separation distance D is formed between one end portion of the burr 346 and the leg inner end portion 3441, the portion with less rigidity may be spaced apart from the leg inner end portion 3441. With such a configuration, the probability of the gasket body 340 being damaged may be reduced.

Referring to FIGS. 7 and 8, in particular embodiments, a diameter of the burr 346 may be approximately 0.1 mm to 1.0 mm. More specifically, the diameter of the burr 346 may be approximately 0.2 mm to 0.8 mm. Even more specifically, the diameter of the burr 346 may be approximately 0.3 mm to 0.4 mm.

Referring to FIG. 8, in particular embodiments, a width W of the concave portion 345 may be approximately 2.0 mm to 7.0 mm. More specifically, the width W of the concave portion 345 may be approximately 3.0 mm to 6.0 mm. Even more specifically, the width W of the concave portion 345 may be approximately 4.0 mm to 4.5 mm.

Further referring to FIG. 8, in particular embodiments, a depth H of the concave portion 345 may be approximately 0.05 mm to 0.2 mm. More specifically, the depth H of the concave portion 345 may be approximately 0.08 mm to 0.15 mm. Even more specifically, the depth H of the concave portion 345 may be approximately 0.08 mm to 0.1 mm.

The burr 346 may be positioned in the concave portion 345. In particular, the burr 346 may be formed at a position corresponding to an inlet for injecting the material of the gasket 34 during the process of making the gasket 34. Since the burr 346 protrudes from the gasket body 340,, the burr 346 may come into contact with the first insulating plate 324 and/or the electrode assembly 32. In particular embodiments, a diameter of the inlet (not illustrated) that forms the burr 346 may be approximately 0.2 mm to 0.5 mm. More specifically, the diameter of the inlet may be approximately 0.25 mm to 0.4 mm. Even more specifically, the diameter of the inlet may be approximately 0.3 mm to 0.35 mm.

Among configurations of the gasket 34, the burr 346 may be formed to be narrow and sharp. Thus, in order to prevent the first insulating plate 324 and/or the electrode assembly 32 from being damaged by the burr 346, it may be necessary to block or minimize the contact between the burr 346 and the first insulating plate 324. As such, the burr 346 may be positioned in the concave portion 345 to prevent the burr 346 from contacting the first insulating plate 324 and/or the electrode assembly 32. As the burr 346 is disposed in the concave portion 345, a distance between the burr 346 and the first insulating plate 324 and/or the electrode assembly 32 is increased as compared to a configuration where the burr 346 is not positioned in a concave portion.

According to an embodiment, the leg step portion 3442 may be positioned closer to the first insulating plate 324 and/or the electrode assembly 32 than the burr 346. Accordingly, when the beading portion 311 and the crimping portion 312 are formed during the process of manufacturing the secondary battery 3, the burr 346 may not protrude further from the leg portion 344 than the leg step portion 3442 even if the shape of the gasket body 340 is deformed. Thus, the burr 346 may be further from the first insulating plate 324 and/or the electrode assembly 32 than the leg step portion 3442 is from the first insulating plate and/or the electrode assembly 32.

Referring again to FIG. 8, in particular embodiments, a height of the burr 346 disposed in the concave portion 345 may be approximately 0.003 mm to 0.1 mm. More specifically, the height of the burr 346 may be approximately 0.005 mm to 0.08 mm. Even more specifically, the height of the burr 346 may be approximately 0.01 mm to 0.04 mm.

A cross-sectional shape of the concave portion 345 may be a quadrangle. According to one particular embodiment, the cross-sectional shape of the concave portion 345 may be approximately trapezoidal. But the cross-sectional shape of the concave portion 345 is not limited to the quadrangle and the concave portion 345 may be provided in other shapes.

As the height of the burr 346 is less than the depth H of the concave portion 345, the burr 346 may protrude less from the gasket body 340 than the concave portion 345. As the burr 346 is spaced apart from the first insulating plate 324 and/or the electrode assembly 32 and the burr 346 is spaced apart from the leg step portion 3442, a failure rate of the secondary battery 3 including a configuration with the burr 346 may be reduced. Further, the rigidity of the gasket body 340 may be improved.

The internal components of a secondary battery and a battery pack including the secondary battery according to the present disclosure have improved the structural strength. In addition, a secondary battery and a battery pack including the secondary battery according to the present disclosure can have a reduced failure rate.

However, the effects obtainable through the present disclosure are not limited to the effects described herein, and other technical effects that are not mentioned will be clearly understood by those skilled in the art.

While the present disclosure has been described with reference to embodiments shown in the drawings, these embodiments are merely illustrative and it should be understood that various modifications and equivalent other embodiments can be derived by those skilled in the art on the basis of the embodiments.

What is claimed is:

1. A secondary battery comprising:
a case having an opening formed therein;
an electrode assembly accommodated in the case;
a cap assembly that seals the opening and is electrically connected to the electrode assembly; and
a gasket disposed between the cap assembly and the case to insulate between the cap assembly and the case, the gasket including a concave groove in a portion of the gasket that faces in a direction towards the electrode assembly.

2. The secondary battery as claimed in claim 1, wherein the cap assembly includes:
an upper cap exposed to outside of the case;
a vent plate disposed between the upper cap and the electrode assembly, the vent plate being electrically connected to the upper cap; and
a lower cap disposed between the vent plate and the electrode assembly, the lower cap being electrically connected to the vent plate and the electrode assembly.

3. The secondary battery as claimed in claim 2, wherein the cap assembly further includes a cap assembly insulating member that is between the vent plate and the electrode assembly, the cap assembly insulating member including an insulating material.

4. The secondary battery as claimed in claim 1, wherein the case includes:
a crimping side portion extending parallel to a longitudinal direction of the case; and
a crimping portion extending from the crimping side portion and bent toward a center of the opening, and
wherein the gasket contacts an inner side of the crimping side portion and an inner side of the crimping portion.

5. The secondary battery as claimed in claim 4, wherein an upper portion of the gasket is in contact with the inner side of the crimping side portion and the inner side of the crimping portion, and
wherein the concave portion is positioned at a lower portion of the gasket.

6. The secondary battery as claimed in claim 5, further comprising an insulating plate disposed between the electrode assembly and the gasket.

7. The secondary battery as claimed in claim 5, wherein the gasket includes:
a crimping contact portion that extends from a position adjacent to the case and is disposed between a crimping portion bent toward a center of the opening and the cap assembly;
a connecting portion connected to the crimping contact portion, the connecting portion being bent and extending toward the electrode assembly, and the connecting portion disposed between the case and the cap assembly;
a support portion connected to the connecting portion, the support portion being bent and extending toward the center of the opening; and
a leg portion connected to the support portion, the leg portion being bent and extending toward the electrode assembly.

8. The secondary battery as claimed in claim 7, wherein the leg portion includes:
a leg inner end portion disposed toward the center of the opening;
a leg outer end portion disposed toward the case; and
a leg step portion disposed between the leg inner end portion and the leg outer end portion.

9. The secondary battery as claimed in claim 8, wherein the concave groove is formed in the leg step portion.

10. The secondary battery as claimed in claim 9, wherein a width of the concave groove is 3.0 mm to 6.0 mm and a depth of the concave groove is 0.08 mm to 0.15 mm.

11. The secondary battery as claimed in claim 8, wherein the gasket further includes a burr protruding from the concave groove toward the electrode assembly.

12. The secondary battery as claimed in claim 11, wherein the burr is spaced 0.03 mm to 0.15 mm from the leg inner end portion.

13. The secondary battery as claimed in claim 11, wherein a diameter of the burr is 0.2 mm to 0.8 mm and a height of burr is 0.005 mm to 0.08 mm.

14. A battery pack comprising:
a housing; and
a plurality of secondary batteries disposed inside the housing,
wherein each of the secondary batteries includes:
a case having an opening formed therein;
an electrode assembly accommodated in the case;
a cap assembly seals the opening and is electrically connected to the electrode assembly; and
a gasket disposed between the cap assembly and the case to insulate between the cap assembly and the case, the gasket including a concave groove in a portion of the gasket that faces in a direction towards the electrode assembly.

15. The battery pack as claimed in claim 14, wherein the cap assembly includes:
an upper cap exposed to outside of the case;
a vent plate disposed between the upper cap and the electrode assembly, the vent plate being electrically connected to the upper cap; and
a lower cap disposed between the vent plate and the electrode assembly, the lower cap being electrically connected to the vent plate and the electrode assembly.

16. The battery pack as claimed in claim 14, wherein the case includes:
a crimping side portion extending parallel to a longitudinal direction of the case; and
a crimping portion extending from the crimping side portion and bent toward a center of the opening, and
wherein the gasket contacts an inner side of the crimping side portion and an inner side of the crimping portion.

17. The battery pack as claimed in claim 16, wherein an upper portion of the gasket is in contact with the inner side of the crimping side portion and the inner side of the crimping portion, and
wherein the concave portion is positioned at a lower portion of the gasket.

18. The battery pack as claimed in claim 17, wherein the gasket includes:
a crimping contact portion that extends from a position adjacent to the case and is disposed between a crimping portion bent toward a center of the opening and the cap assembly;
a connecting portion connected to the crimping contact portion, the connecting portion being bent and extending toward the electrode assembly, and the connecting portion disposed between the case and the cap assembly;
a support portion connected to the connecting portion, the support portion being bent and extending toward the center of the opening; and
a leg portion connected to the support portion, and the leg portion being bent and extending toward the electrode assembly.

19. The battery pack as claimed in claim 18, wherein the leg portion includes:
a leg inner end portion disposed toward the center of the opening;
a leg outer end portion disposed toward the case; and
a leg step portion disposed between the leg inner end portion and the leg outer end portion.

20. The battery pack as claimed in claim 19, wherein the concave groove is formed in the leg step portion.
